(19) United States
(12) Patent Application Publication
(10) Pub. No.: US 2005/0216588 A1
(43) Pub. Date: Sep. 29, 2005

(54) Blocking specified unread messages to avoid mailbox overflow

(75) Inventors: Susann Marie Keohane, Austin, TX (US); Gerald Francis McBrearty, Austin, TX (US); Shawn Patrick Mullen, Buda, TX (US); Jessica Murillo, Hutto, TX (US); Johnny Meng-Han Shieh, Austin, TX (US)

Correspondence Address: IBM CORP (AP);C/O AMY PATTILLO, P. O. BOX 161327, AUSTIN, TX, 78716, US

(73) Assignee: International Business Machines Corporation, Armonk, NY (US)

(21) Appl. No.: 10/809,590

(22) Filed: Mar. 25, 2004

(51) Int. Cl. G06F 15/173

(52) U.S. Cl. 709/225; 709/224

(57) ABSTRACT

A system, system, and program for managing message storage are provided. A messaging client receives new messages for an intended recipient. The messaging client controls storage of these new messages in a message storage system of fixed capacity. The messaging client monitors the usage percentage of the capacity of the message storage system. When the messaging client receives a new message, the messaging client determines whether the sender identifier of the message and the usage percentage match with a criteria for blocking messages as set by the intended recipient. If the new message sender identifier and the usage percentage match the criteria for blocking, then the messaging client blocks the message from being stored in the message storage system, such that the intended recipient is enabled to specify blocking preferences which are then implemented by the messaging client to avoid overflowing the message storage capacity with less important unread messages.

### BACKGROUND OF THE INVENTION

1. Technical Field

The present invention relates in general to improved messaging systems and in particular to improved storage management within messaging systems. Still more particularly, the present invention relates to filtering electronic messages to block specified messages when the usage of a mailbox exceeds or would exceed a particular threshold.

2. Description of the Related Art

The use of electronic mail (email) and other electronic messaging and communications, such as instant messaging, has expanded rapidly over the last few years. Electronic messaging is facilitated my millions of servers which send and receive electronic communications. For example, email client servers are designated within networks to receive and hold emails for intended recipients. Typically, recipients then log on to the email client server or directly access the email client server to retrieve held emails.

After a recipient accesses an email, the recipient may decide to store the email. Typically, an email client server provides storage for holding unread email and for storing opened email in folders.

Some email client servers, such as yahoo.com and hotmail.com, provide free electronic mail accounts to millions of users. Along with free service, however, often comes a fixed amount of storage space.

Whether from a free service, a company service, or personal service, as a recipient stores emails in a fixed storage space available to the email client server, the available capacity of the storage space remaining for unread email to wait is reduced. Disadvantageously, when the fixed storage area for email messages is full, new messages received at the email client server are typically discarded.

In addition to filling up with read and stored emails, email storage space is often used up by spam or junk email that is not requested or desired by a recipient. Many methods for attempting to identify and filter out spam or junk emails continue to develop, however, none are perfect. Sometimes, email that a recipient does want is discarded and other times email that a recipient does not want still gets through.

Ultimately, as an email storage space fills up, there are some messages that are more important to a recipient to receive than others. For example, when there is only space for 5 more messages to be held for the intended recipient, it might be more important to business emails to be held, rather than personal emails. However, currently, there is not a way for a recipient to prioritize and specify messages as the storage capacity available for holding new messages decreases.

In view of the foregoing, it would be advantageous to provide a method, system, and program for a user to specify and prioritize which senders' messages should be received and blocked when the usage of the storage capacity reaches user specified thresholds. In particular, it would be advantageous to provide a method, system, and program for a mail client server to then filter new messages received for the user and block those that are not desired as the available storage capacity diminishes.

### SUMMARY OF THE INVENTION

Therefore, the present invention provides for improved messaging systems and in particular for improved storage management within messaging systems. Still more particularly, the present invention provides a method, system, and program for filtering electronic messages to block specified messages when the usage of the capacity of a mailbox exceeds or would exceed a particular level.

According to one embodiment of the invention, a messaging client receives new messages for an intended recipient. The messaging client controls storage of these new messages in a message storage system of fixed capacity. The messaging client monitors the usage percentage of the capacity of the message storage system. When the messaging client receives a new message, the messaging client determines whether the sender identifier of the message and the usage percentage match with a criteria for blocking messages. The criteria for blocking messages is set by the intended recipient. If the new message sender identifier and the usage percentage match the criteria for blocking, then the messaging client blocks the message from being stored in the message storage system, such that the intended recipient is enabled to specify blocking preferences which are then implemented by the messaging client to avoid overflowing the storage capacity with less important unread messages.

In particular, an intended recipient may designate sender identifiers that should be blocked when usage percentages increase above designated thresholds. In one embodiment, the intended recipient may specify to block messages when the addition of the message to the message storage system would result in the usage percentage increasing above the usage percentage threshold. In another embodiment, the intended recipient may specify to block messages when the usage percentage has already increased above the usage percentage threshold.

In addition, in particular, an intended recipient may also a usage percentage threshold so that when the actual usage percentage exceeds the threshold, then only designated sender identifiers are not blocked. Thus, the intended recipient is enabled to select the usage percentage threshold above which only certain messages will be stored to reduce the chances that the storage system will become full and throw away important messages.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a block diagram depicting a distributed network system for facilitating distribution of electronic messages between a sender and a recipient for facilitating one embodiment of the present invention;

FIG. 3 is a block diagram depicting a client mail system in accordance with the present invention;

FIG. 4 is a block diagram depicting a mail capacity settings window for a user to specify mail blocking preferences;

FIG. 5 is a block diagram depicting a mailbox storage space for a particular recipient in accordance with the method, system, and program of the present invention; and

FIG. 6 is a high level logic flowchart of a process and program for controlling message filtering at an email client in accordance with the method, system, and program of the present invention.

### DETAILED DESCRIPTION OF THE PREFERRED EMBODIMENT

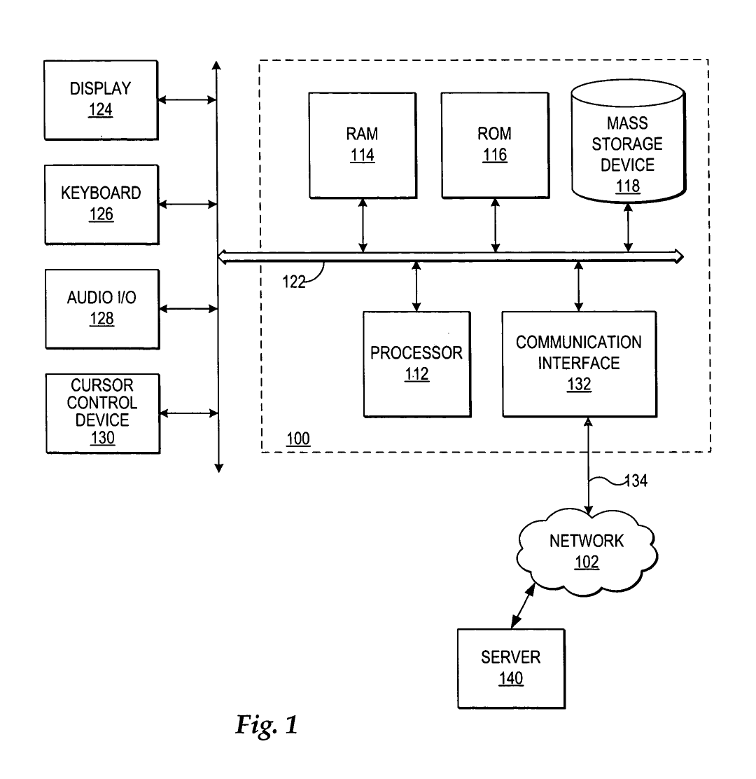

Referring now to the drawings and in particular to FIG. 1, there is depicted one embodiment of a system through which the present method, system, and program may be implemented. The present invention may be executed in a variety of systems, including a variety of computing systems and electronic devices.

Computer system 100 includes a bus 122 or other communication device for communicating information within computer system 100, and at least one processing device such as processor 112, coupled to bus 122 for processing information. Bus 122 preferably includes low-latency and higher latency paths that are connected by bridges and adapters and controlled within computer system 100 by multiple bus controllers. When implemented as a server system, computer system 100 typically includes multiple processors designed to improve network servicing power.

Processor 112 may be a general-purpose processor such as IBM's PowerPC™ processor that, during normal operation, processes data under the control of operating system and application software accessible from a dynamic storage device such as random access memory (RAM) 114 and a static storage device such as Read Only Memory (ROM) 116. The operating system preferably provides a graphical user interface (GUI) to the user. In a preferred embodiment, application software contains machine executable instructions that when executed on processor 112 carry out the operations depicted in the flowcharts of FIGS. 9, 10, 11, and others described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but will be understood to also be provided by an external device. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, the present invention may be downloaded as a computer program product, wherein the program instructions may be transferred from a remote computer such as a server 140 to requesting computer system 100 by way of data signals embodied in a carrier wave or other propagation medium via a network link 134 (e.g. a modem or network connection) to a communications interface 132 coupled to bus 122. Communications interface 132 provides a two-way data communications coupling to network link 134 that may be connected, for example, to a local area network (LAN), wide area network (WAN), or an Internet Service Provider (ISP). In particular, network link 134 may provide wired and/or wireless network communications to one or more networks.

Network link 134 provides data communication services through network 102. Network 102 may refer to the worldwide collection of networks and gateways that use a particular protocol, such as Transmission Control Protocol (TCP) and Internet Protocol (IP), to communicate with one another. Network link 134 and network 102 both use electrical, electromagnetic, or optical signals that carry digital data streams. The signals through the various networks and the signals on network link 134 and through communication interface 132, which carry the digital data to and from computer system 100, are exemplary forms of carrier waves transporting the information.

When implemented as a server system, computer system 100 typically includes multiple communication interfaces accessible via multiple peripheral component interconnect (PCI) bus bridges connected to an input/output controller. In this manner, computer system 100 allows connections to multiple network computers.

In addition, computer system 100 typically includes multiple peripheral components that facilitate communication. These peripheral components are connected to multiple controllers, adapters, and expansion slots coupled to one of the multiple levels of bus 122. For example, an audio input/output (I/O) device 128 is connectively enabled on bus 122 for controlling audio outputs and inputs. A display device 124 is also connectively enabled on bus 122 for providing visual, tactile or other graphical representation formats and a cursor control device 130 is connectively enabled on bus 122 for controlling the location of a pointer within display device 124. A keyboard 126 is connectively enabled on bus 122 as an interface for user inputs to computer system 100. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

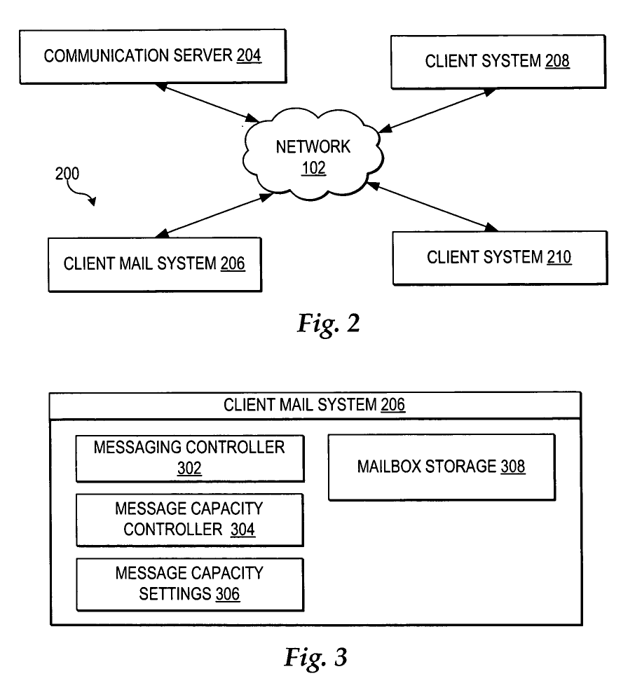

With reference now to FIG. 2, a block diagram depicts a distributed network system for facilitating distribution of electronic messages between a sender and a recipient for facilitating one embodiment of the present invention. Distributed data processing system 200 is a network of computers in one embodiment of the invention may be implemented. It will be understood that the present invention may be implemented in other embodiments of systems enabled to communicate via a connection.

In the embodiment, distributed data processing system 200 contains network 102, which is the medium used to provide communications links between various devices and computers connected together within distributed data processing system 200. Network 102 may include permanent connections such as wire or fiber optics cables, temporary connections made through telephone connections and wireless transmission connections.

In addition, in the embodiment, distributed data processing system 200 includes client systems 208 and 210. Messaging applications residing on client systems 208 and 210 provide an interface for implementing messaging services on client system 208 and client system 210. For example, a sender at client system 208 may interact with a mail application to create and send an electronic message intended for a particular recipient. The sender's address and recipient's address are included in the electronic message. A communication server 204 receives the electronic message from client system 208 and distributes the electronic message to client mail system 206. Client mail system 206 includes a database for receiving and storing electronic mail addressed to a particular recipient. The recipient may access client mail system 206 directly to retrieve messages, or may login to client mail system 206 via the messaging application executing on another client system, such as client system 210. In addition, distributed data processing system 200 may include additional servers, clients, and other devices not shown. For example, electronic messages may be sent and received between communication server 204 and other servers (not shown) to distribute and receive messages from other clients (not shown).

The client/server environment of distributed data processing system 200 is implemented within many network architectures. In one example, distributed data processing system 200 is implemented through the Internet with network 102 representing a worldwide collection of networks and gateways that use the TCP/IP suite of protocols to communicate with one another. The Internet is enabled by millions of high-speed data communication lines between major nodes or host computers. In another example, distributed data processing system 200 is implemented as an intranet, a local area network (LAN), or a wide area network (WAN). Moreover, distributed data processing system 200 may be implemented in networks employing alternatives to a traditional client/server environment, such as a grid computing environment.

Within distributed data processing system 200, each of client systems 208 and 210, communication server 204, and client mail system 206 may function as both a “client” and a “server” and may be implemented utilizing a computer system such as computer system 100 of FIG. 1. Further, while the present invention is described with emphasis upon communication server 204 and client mail system 206 facilitating the transfer of electronic messages, the present invention may also be performed by client systems 208 and 210 engaged in peer-to-peer network communications and downloading via network 102.

According to an advantage of the present invention, a user may specify filtering preferences for client mail system 206 to apply to each message received at client mail system 206 for the user. The filtering preferences may specify which sender addressed messages to block from the user's mailbox when usage of the capacity of the mailbox reaches a particular percentage. For example, a user may specify to block all messages from the sender address “info@info.com” if storing the message as incoming mail would increase the usage of the mailbox capacity above 90%. The filtering preferences may also specify at what percentage capacity usage to block all message except those specified by the user. For example, a user may specify to block all messages one the mailbox capacity reaches 95%, except those messages sent with the domain of “ibm.com”.

For purposes of the present invention, electronic messages may include, but are not limited to, e-mail messages, instant messaging, chat sessions, and other forms of text, graphics, audio, and video communications between systems, facilitated by a network. Although the present embodiment is described with emphasis upon an e-mail as the electronic message, it will be understood that the present invention applies to electronic message filing systems for multiple types of electronic messages.

Referring now to FIG. 3, there is depicted a block diagram of a client mail system in accordance with the present invention. As depicted, client mail system 206 includes a messaging controller 302 for controlling the receipt and transmission of messages for a particular user.

According to an advantage of the present invention, a recipient may specify filtering preferences for blocking out messages from storage as the available capacity for storage reaches specified thresholds. The blocking preferences are stored in message capacity settings file 306. Message capacity controller 304 filters each message with message capacity settings to determine whether the message should be blocked from placement in mailbox storage 308. In particular, message capacity controller 304 monitors the percentage of the capacity of mailbox storage 308 that is currently in use. Further, in particular, message capacity controller 304 determines what percentage of the capacity of mailbox storage 308 would be used if a new message is placed in mailbox storage 308. Then, message capacity controller 304 can determine whether a particular message meets the criteria to be blocked or allowed based on the current capacity available in mailbox storage 308.

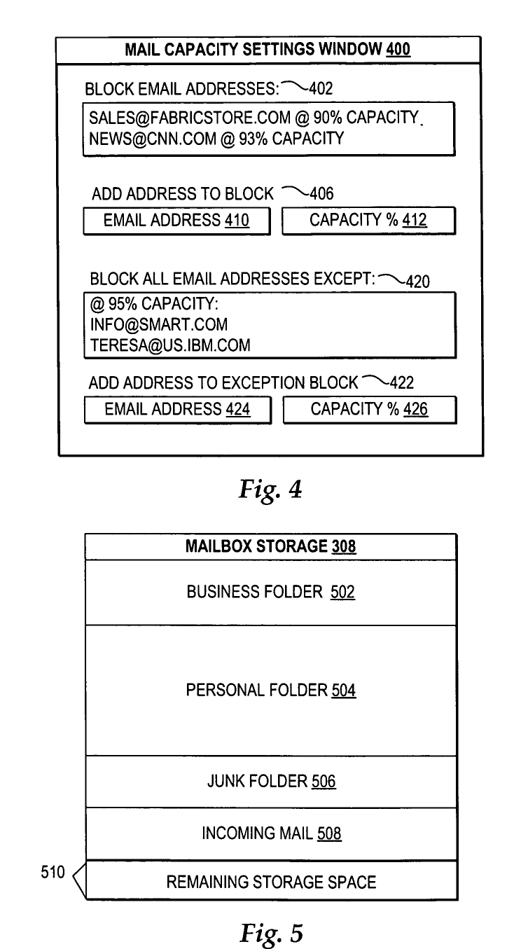

With reference now to FIG. 4, there is depicted a block diagram of a mail capacity settings window for a user to specify mail blocking preferences. As depicted, a mail capacity settings window 400 includes input areas for a user to specify mail blocking preferences.

As depicted at reference numeral 402, a user has specified to block messages received from two addresses when the mailbox storage reaches 90% capacity and 93% capacity. As depicted at reference numeral 406, a user may specify additional addresses to block at reference numeral 410 and assign a capacity percentage at which to start blocking at reference numeral 412. It is important to note that when specifying an email or other type of electronic message address, the user may specify a full specific address, classes of addresses, or other criteria for identifying addresses to block. Further, it is important to note that as an alternative to a capacity percentage, other measurable usage of the mailbox storage may be specified. In addition, a user may specify to start blocking a particular address when a particular folder within the mailbox storage reaches a particular capacity percentage.

In addition, as depicted at reference numeral 410, a user has specified to block all addresses when 95% capacity is reached except for two particular addresses. Then, as depicted at reference numeral 422, a user may specify additional addresses to except from blocking when a particular percentage usage of the mailbox storage capacity is reached.

Referring now to FIG. 5, there is depicted a block diagram of a mailbox storage space for a particular recipient in accordance with the method, system, and program of the present invention. As depicted, mailbox storage 308 may be subdivided into storage folders, such as business folder 502, personal folder 504, and junk folder 506. In addition, mailbox storage 308 may include an incoming mail folder 508.

Each of the folders currently uses a particular percentage of the storage capacity for mailbox storage 308. Remaining storage space 510 indicates the portions of the storage capacity for mailbox storage 308 that is currently unused.

When new messages are received, they may be blocked or allowed into mailbox storage 308. A message may be further filtered to specify the type of message and sorted into one of the folders in mailbox storage 308. It will be understood that multiple methods of sorting messages that are not blocked within mailbox storage 308 may be implemented. For example, a user may specify criteria for determining whether a message is junk mail and if a message meets the criteria, but is not blocked, then the message is automatically placed in junk folder 506.

As previously described, the user may specify filtering preferences for blocking messages from mailbox storage 308 when usage of the capacity of mailbox storage 308 reaches a particular percentage. In addition, a user may specifying filtering preferences for blocking messages based on the percentage usage of the capacity of mailbox storage 308 by a particular folder. For example, when junk folder 506 reaches 50% of the total capacity of mailbox storage 308, any messages which would be directed to that folder are blocked.

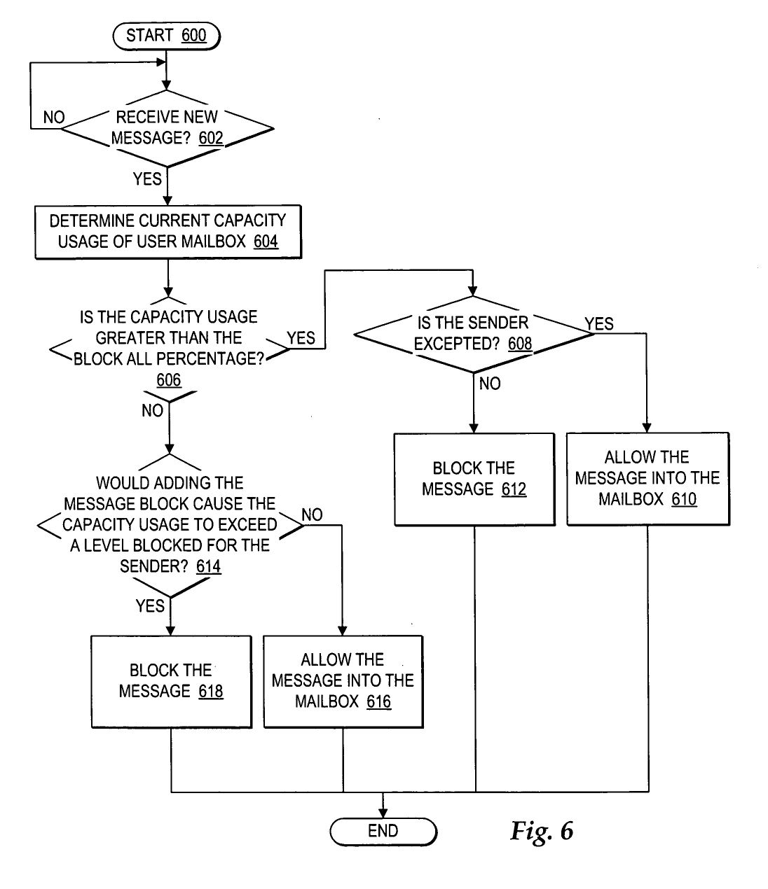

With reference now to FIG. 6, there is depicted a high level logic flowchart of a process and program for controlling message filtering at an email client in accordance with the method, system, and program of the present invention. As depicted, the process starts at block 600 and thereafter proceeds to block 602. Block 602 depicts a determination whether a new message is received. If a new message is not received, then the process iterates at block 602. If a new message is received, then the process passes to block 604. Block 604 depicts determining the current capacity usage of the user mailbox. Next, block 606 depicts a determination whether the capacity usage is greater than the block all percentage set by the recipient.

At block 606, if the capacity usage is greater than the block all percentage set by the recipient, then the process passes to block 608. Block 608 depicts a determination whether the sender is excepted from the block all specification. If the sender is not excepted, then the process passes to block 612. Block 612 depicts blocking the message, and the process ends. Otherwise, at block 608, if the sender is excepted, then the process passes to block 610. Block 610 depicts allowing the message into the mailbox, and the process ends.

At block 606, if the capacity usage is not greater than the block all percentage set by the recipient, then the process passes to block 614. Block 614 depicts a determination whether adding the message would cause the capacity usage to exceed a level blocked for the sender. If adding the message would cause the capacity usage to exceed a level blocked for the sender, then the process passes to block 618. Block 618 depicts blocking the messaging, and the process ends. Otherwise, at block 614, if adding the message does not cause the capacity usage to exceed a level blocked for the sender, then the process passes to block 616. Block 616 depicts allowing the message into the mailbox, and the process ends.

While the invention has been particularly shown and described with reference to a preferred embodiment, it will be understood by those skilled in the art that various changes in form and detail may be made therein without departing from the spirit and scope of the invention.

1. A method for controlling received electronic message storage comprising:
receiving a message with sender identification at a messaging client controlling storage of a plurality of messages for an intended recipient in a message storage system;
detecting a usage percentage of a capacity of said message storage system;
comparing said sender identifier and said usage percentage with at least one criteria for blocking messages as specified by said intended recipient; and
responsive to said sender identifier at said usage percentage meeting said criteria for blocking, blocking said message from said message storage system, such that said intended recipient is enabled to specify blocking preferences which are implemented by said messaging client to avoid exceeding storage capacity with unread messages.

2. The method according to claim 1 for controlling received electronic message storage, wherein detecting a usage percentage further comprises:
detecting said usage percentage of said capacity of said message storage system, wherein said message storage system is a folder from among a plurality of folders for storing messages in said message storage system.

3. The method according to claim 1 for controlling received electronic message storage, wherein receiving a message with sender identification further comprises:
receiving an electronic mail message wherein said sender identification comprises an electronic mail address.

4. The method according to claim 1 for controlling received electronic message storage, wherein comparing said sender identifier and said usage percentage with said at least one criteria further comprises:
comparing said sender identifier with a plurality of sender identifiers each designated by said intended recipient to be blocked when a particular usage percentage is reached.

5. The method according to claim 1 for controlling received electronic message storage, wherein comparing said sender identifier and said usage percentage with said at least one criteria further comprises:
comparing said sender identifier with a plurality of sender identifiers each designated to be excepted from blocking when a particular usage percentage is reached.

6. The method according to claim 1 for controlling received electronic message storage, further comprising:
controlling an interface for said intended recipient to specify said at least one criteria.

7. A system for controlling received electronic message storage comprising:
a messaging client communicatively connected to a network for facilitating receipt of new messages over said network for an intended recipient, said messaging client further comprising a message storage system for storing a plurality of messages for said intended recipient;
said messaging client further comprising:
means for receiving, for said intended recipient, a new message with a sender identification;
means for detecting a usage percentage of a capacity of said message storage system;
means for comparing said sender identifier and said usage percentage with at least one criteria for blocking messages as specified by said intended recipient; and
responsive to said sender identifier at said usage percentage meeting said criteria for blocking, blocking said new message from said message storage system.

8. The system according to claim 7 for controlling received electronic message storage, wherein said means for detecting a usage percentage further comprises:
means for detecting said usage percentage of said capacity of a folder from among a plurality of folders for storing messages in said message storage system.

9. The system according to claim 7 for controlling received electronic message storage, wherein said means for receiving a message with sender identification further comprises:
means for receiving an electronic mail message wherein said sender identification comprises an electronic mail address.

10. The system according to claim 7 for controlling received electronic message storage, wherein said means for comparing said sender identifier and said usage percentage with said at least one criteria further comprises:
means for comparing said sender identifier with a plurality of sender identifiers each designated by said intended recipient to be blocked when a particular usage percentage is reached.

11. The system according to claim 7 for controlling received electronic message storage, wherein said means for comparing said sender identifier and said usage percentage with said at least one criteria further comprises:
means for comparing said sender identifier with a plurality of sender identifiers each designated to be excepted from blocking when a particular usage percentage is reached.

12. The system according to claim 7 for controlling received electronic message storage, further comprising:
means for controlling an interface for said intended recipient to specify said at least one criteria.

13. A computer program product, residing on a computer readable medium, for controlling received electronic message storage comprising:
means for enabling receipt of a message with sender identification at a messaging client controlling storage of a plurality of messages for an intended recipient in a message storage system;
means for detecting a usage percentage of a capacity of said message storage system;
means for comparing said sender identifier and said usage percentage with at least one criteria for blocking messages as specified by said intended recipient; and
means, responsive to said sender identifier at said usage percentage meeting said criteria for blocking, for blocking said message from said message storage system.

14. The computer program product according to claim 13 for controlling received electronic message storage, wherein said means for detecting a usage percentage further comprise:
means for detecting said usage percentage of said capacity of a folder from among a plurality of folders for storing messages in said message storage system.

15. The computer program product according to claim 13 for controlling received electronic message storage, wherein said means for enabling receipt of a message with sender identification further comprises:
means for enabling receipt of an electronic mail message wherein said sender identification comprises an electronic mail address.

16. The computer program product according to claim 13 for controlling received electronic message storage, wherein said means for comparing said sender identifier and said usage percentage with said at least one criteria further comprises:
means for comparing said sender identifier with a plurality of sender identifiers each designated by said intended recipient to be blocked when a particular usage percentage is reached.

17. The computer program product according to claim 13 for controlling received electronic message storage, wherein said means for comparing said sender identifier and said usage percentage with said at least one criteria further comprises:
means for comparing said sender identifier with a plurality of sender identifiers each designated to be excepted from blocking when a particular usage percentage is reached.

18. The computer program product according to claim 13 for controlling received electronic message storage, further comprising:
means for controlling an interface for said intended recipient to specify said at least one criteria.
